(19) United States
(12) Patent Application Publication
(10) Pub. No.: US 2013/0032054 A1
(43) Pub. Date: Feb. 7, 2013

(54) Actuator Providing Multiple Actuation

(71) Applicants: Richard Schneider, Lohningen (CH); Eduard Mesnjak, Radolfzell (DE); Anton Gaile, Leutkirch (DE); Thomas Kloos, Wangen (DE)

(72) Inventors: Richard Schneider, Lohningen (CH); Eduard Mesnjak, Radolfzell (DE); Anton Gaile, Leutkirch (DE); Thomas Kloos, Wangen (DE)

(73) Assignees: LIEBHERR-AEROSPACE LINDENBERG GMBH, Lindenberg (DE); BOMBARDIER TRANSPORTATION GMBH, Berlin (DE)

(21) Appl. No.: 13/395,981

(22) PCT Filed: Sep. 14, 2010
(86) PCT No.: PCT/EP2010/063482

§ 371 Date: Sep. 18, 2012

(30) Foreign Application Priority Data
Sep. 15, 2009 (DE) 10 2009 041 110.0

(51) Int. Cl. B61F 5/50; F15B 15/20

(52) U.S. Cl. 105/199.1; 91/418

(57) ABSTRACT

Disclosed is an actuator, in particular for a rail vehicle, comprising a fluidic first actuator unit and a control device having a first control unit, wherein the first actuator unit is connected to the first control unit and can be supplied with power from a fluidic power source under the control of the first control unit. Furthermore, a fluidic second actuator unit is provided, and the control device comprises a second control unit, wherein the second actuator unit is connected to the second control unit and can be supplied with power from the fluidic power source under the control of the second control unit. The invention further relates to a vehicle, in particular a rail vehicle, having an actuator according to the invention.

The present invention relates to an actuator, in particular for a rail vehicle, comprising a fluidic first actuator unit and a control device having a first control unit, wherein the first actuator unit is connected to the first control unit and can be supplied with power from a fluidic power source controlled by means of the first control unit. The invention further relates to a vehicle having such an actuator.

In rail vehicles—but also in other vehicles—the wagon body is usually spring-mounted by means of one or a plurality of spring stages on the wheel units (for example individual wheels, wheel pairs or wheelsets). Not least due to the constantly increasing demands for vehicle safety, passenger comfort and transport capacity, as well as the lifetime of the vehicles, from the vehicle dynamics point of view numerous problems arise which can no longer be satisfactorily solved with a passive system.

The centrifugal acceleration that occurs when negotiating a curve and which acts transversely to the movement and thus transversely to the longitudinal axis of the vehicle, due to the comparatively high centre of gravity of the wagon body, results in a tendency of the body to tilt in relation to the wheel units towards the outside of the curve, and thus to perform a rolling movement about a roll axis parallel to the longitudinal axis of the vehicle.

Above certain thresholds such rolling movements can reduce the travel comfort. There is also a danger of them causing the permitted clearance gauge to be breached and in addition, with regard to stability and thus also running safety, a danger of inadmissible unilateral wheel unloading. In order to prevent this, in modern rail vehicles roll support devices are often used in the form of so-called roll stabilisers and active tilting systems, to counteract excessive rolling or tilting movements and to set the rolling or tilting angle and the roll axis of the vehicle as far as possible at the optimum value for the respective running conditions. Such an approach is for example known from EP 1 190 925 A1 (the entire disclosure of which is included herein by reference).

A further vehicle dynamics problem results in connection with the active influence of the steering angle of the wheel units both on straight track and on curves. Here again active systems are often used which, with regard to travel safety (avoidance of unstable running conditions), passenger comfort (reduction of uncomfortable vibrations in the vehicle) and not least wear of the wheel and rails, actively set the steering angle of one or a plurality of wheel units of the vehicle as far as possible at the optimum value for the respective running conditions. Such an approach is for example known from WO 03/010039 A1 and from WO 2007/137906 A1 (the entire disclosure of which is in each case included herein by reference).

The problem here is that, as a rule, a plurality of actuators must be used in order to meet the various demands of the respective active systems. This is a disadvantage from the building space point of view, since in the area of the running gear of modern rail vehicles, as a rule, very little building space is available.

The problem for the present invention is therefore to provide an actuator or a vehicle of the kind mentioned at the outset which does not have, or at least only to a lesser extent, the abovementioned disadvantages and, in particular, allows the performance of multiple adjusting movements in the running gear area with a compact, space-saving design, in a simple and reliable manner.

The present invention achieves the object on the basis of an actuator according to the preamble of claim 1 by the features indicated in the characterising part of claim 1.

The present invention is based on the technical teaching that in a simple and reliable manner a compact design of the actuator can be achieved with the simultaneous execution of a plurality of separate adjusting movements, if a plurality of actuator units are integrated into the actuator, which are separately controlled but are supplied with working fluid from a shared power source. It has turned out that from a plurality of actuator units, which provide separately controlled adjusting movements (possibly different applications), and a shared power source, a very compact design of the actuator can be achieved. This compact design allows in an advantageous manner the integration of the actuator in a running gear of a modern rail vehicle without massively influencing its building room budget.

According to a first aspect the present invention therefore relates to an actuator, in particular for a rail vehicle, comprising a fluidic first actuator unit and a control device having a first control unit, wherein the first actuator unit is connected to the first control unit and, under the control of the first control unit, can be supplied with power from a fluidic power source. A fluidic second actuator unit is also provided and the control device comprises a second control unit, wherein the second actuator unit is connected to the second control unit and, under the control of the second control unit, can be supplied with power from the fluidic power source.

The actuator can basically be constructed from a plurality of separate components, which preferably are, however, arranged spatially closely associated to one another in order to provide the shortest possible routes for the working fluid. This is an advantage with regard to the (fluidic) rigidity of the system (short, mechanically stiff routes) and, thus, the achievable control bandwidth as well as the performance of the system (low losses due to low volume of working fluid in the system).

The actuator preferably takes the form of a structural unit, in particular with a shared housing, since in this way a particularly compact, advantageous design can be achieved. The first control unit and the second control unit preferably take the form of a common structural subunit of the actuator. Here again, not least from the building space point of view, it is advantageous if the two control units are provided with a shared housing.

Additionally or alternatively the first actuator unit and the second actuator unit can take the form of a common structural subunit of the actuator. Here also the first and second actuator unit can again be provided with a shared housing. The first actuator unit and the second actuator unit are preferably arranged directly adjacent to one another in order to achieve a particularly compact arrangement.

Finally, additionally or alternatively, the power source can be formed as a structural subunit of the actuator. The power source may simply be designed as a shared buffer store (of sufficient size), which is supplied with the working fluid by a suitable pump. Similarly, however, the power source can also simply be a pump, which with sufficient dynamics provides a sufficiently high volumetric flow for the respective application.

Preferably, the power source comprises a motor, a pump for a working fluid driven by the motor and a buffer store supplied by the pump with the working fluid, which are arranged in a shared housing. In this way a particularly compact arrangement can be achieved which thanks to the volume (selected to be suitably large) of the buffer store allows supply of the actuator units with high dynamics using comparatively simple components.

The control units can in each case be designed in any suitable fashion in order to supply the respective actuator unit with working fluid in a controlled manner. Thus, for example, additional separately controllable pumps can be provided which supply the respective actuator unit with working fluid.

Preferably, however, simple valve units are provided, which merely control the volume flow rate and/or the pressure level of the working fluid already acted upon with sufficient pressure by the power source. Such valve units have the advantage that, with a comparatively simple design, they allow a broad control bandwidth, which from a dynamics point of view is an advantage.

In preferred variants of the actuator according to the invention the first control unit therefore comprises at least a first valve unit, which, under the control of a control module of the control device, connects the power source in a fluidic manner with the first actuator unit. Basically, a single valve unit may suffice, but preferably a plurality of valve units is provided, in order in a simple manner to create redundancy and thus increase the reliability. Here it can be provided that in each case only one of the two valve units of the control unit is operated. It is self-evident, however, that in other variants parallel operation of the two valve units can be envisaged. Preferably, the first control unit therefore comprises two first valve units, which preferably can be separately controlled by the control module and/or can be operated in parallel.

Additionally or alternatively, the second control unit comprises at least a second valve unit, which, under the control of a control module of the control device, connects the power source in a fluidic manner with the second actuator unit. Here also the second control unit can comprise two second valve units, which in particular can be separately controlled by the control module and/or can be operated in parallel.

The two actuator units can basically be controlled in any suitable fashion. In particular, they can both be controlled in the same frequency range. In preferred variants of the actuator according to the invention, however, it is provided that the control device is designed to control the first control unit for operation of the first actuator unit in a first frequency range, and the second control unit for operation of the second actuator unit in a second frequency range, wherein the second frequency range, in particular, at least in part, in particular completely, lies above the first frequency range. In particular, the first frequency range can in particular range from 0 Hz to 2 Hz, preferably from 0.5 Hz to 1.0 Hz, while the second frequency range, additionally or alternatively, can range from 0.5 Hz to 15 Hz, preferably from 1.0 Hz to 6.0 Hz. In this way, with a single actuator according to the invention complex control systems can be created, in which adjusting movements of differing frequencies and/or differing amplitudes can be overlaid with one another and applied to a component to be operated (for example a vehicle).

In further advantageous variants of the actuator according to the invention the first control unit comprises two first valve units, wherein at least one of the first valve units is designed for control in the second frequency range. In this way it is possible, in the event of failure of the second actuator unit to have its function performed by corresponding control of one of the first valve units (at least to a reduced extent). Additionally or alternatively, in a similar manner the second control unit can comprise two second valve units, wherein at least one of the second valve units is designed for control in the first frequency range.

The two actuator units can basically be designed in any suitable fashion. In particular, they can have any working movements or working directions. Preferably, at least one of the actuator units is an actuator unit with rotary action and/or at least one of the actuator units is an actuator unit with translational action. Here, the first actuator unit and the second actuator unit can have a different working direction, since in this way in a particularly simple fashion complex adjusting tasks can be performed.

In a further preferred configuration of the actuator according to the invention at least one further, third actuator unit is provided, wherein the third actuator unit is connected to a third control unit of the control device and, under the control of the third control unit, can be supplied with power from the power source. In this way in a simple fashion it is possible, with a very compact design as before, to perform further separate adjusting movements. Preferably at least two third actuator units are provided, in order to be able to perform particularly complex adjusting tasks.

For the fluidic connection of the individual components of the actuator basically any suitable components, such as pipe connections and/or hose connections, can be used. Preferably, however, the actuator is substantially free from internal fluidic pipe and/or hose connections, in order to avoid reducing the rigidity of the fluid system through the elasticity of such components.

Block-like design units are preferably used, in which the channels for carrying the working fluid are formed, so that a high rigidity of the fluid system is guaranteed. These blocks are then preferably directly connected to each other, in order to achieve, also in the area of their connection, a positive design in terms of rigidity.

Preferably, therefore the first control unit is designed as a valve block, which in order to create the fluidic connection is flange-mounted to the first actuator unit and/or the power source. Additionally or alternatively, the second control unit can be designed as a valve block, which again in order to create the fluidic connection is flange-mounted to the second actuator unit and/or the power source. In this way a particularly compact design with advantageously short routings and high rigidity of the fluid system is achieved.

For the working fluid basically any suitable fluid (thus a gas or a liquid) can be used. With regard to the rigidity of the fluid system, preferably, liquid media are used. Here it is preferably a case of hydraulic oil.

The present invention further relates to a vehicle, in particular a rail vehicle, with a running gear, a wagon body supported by the running gear and a first actuator according to the invention. With this vehicle the advantages and variants described above can be achieved to the same extent, so that in this context reference is simply made to the above statements.

Basically, the use of the first actuator is sufficient. In addition to the first actuator, however, at least one second actuator according to the invention can be provided. In this way particularly complex control tasks can be performed in the vehicle.

The actuator can basically be provided in any suitable point in the vehicle, and perform any adjusting tasks there. Particularly advantageously, however, the actuators according to the invention (not least thanks to the broad control bandwidth that can be achieved) can be used for adjusting tasks in the vehicle, which are relevant from the vehicle dynamics point of view. The actuators according to the invention are therefore preferably arranged in the running gear or in the area of the interface between the running gear and the wagon body, respectively. It is therefore preferably provided that the first actuator and/or the second actuator acts in the area of the running gear and/or between the running gear and the wagon body.

The actuator can be used in the vehicle at any suitable point for any adjusting tasks. Thus, for example, it can be used in the area of height levelling, in the area of hydraulic braking or in the area of active dampers. Particularly advantageously, however, it can be used in connection with the tilting of the wagon body about a rolling axis parallel to the longitudinal axis of the vehicle. The wagon body can therefore preferably tilt about a longitudinal axis of the vehicle and at least one actuator unit of the first actuator is designed to set a tilting angle of the wagon body about the longitudinal axis, in particular in a first frequency range. Preferably, at least one further actuator unit of the first actuator and/or of the second actuator is then designed to set the tilting angle of the wagon body in a second frequency range, wherein the second frequency range lies preferably at least in part, in particular completely, above the first frequency range. In this way a particularly advantageous influencing of the travel comfort for passengers in the vehicle can be achieved, as already illustrated at the outset.

Furthermore, the actuator according to the invention can also be used particularly advantageously in connection with the steering orientation of the wheel units of the running gear. Preferably therefore the running gear has at least one wheel unit that is steerable about a vertical axis of the vehicle and at least one actuator unit of the first actuator is designed in order to set a steering angle of the wheel unit, in particular in a third frequency range, about the vertical axis. Preferably then, in turn, at least one further actuator unit of the first actuator and/or of the second actuator is designed in order to set the steering angle of the wheel unit in a fourth frequency range, wherein the fourth frequency range in particular at least partially, in particular completely, lies above the third frequency range. In this way a particularly advantageous influencing of the running behaviour of the vehicle can be achieved, as already illustrated at the outset.

The two actuators can basically be built as components that are completely independent of one another. Preferably, however, it is envisaged that the first actuator and the second actuator are connected with each other in a fluidic manner, so that, in the event of failure of the power source of one actuator, the power source of the other actuator can take over the power supply to both actuators. This allows the reliability of the system as a whole to be increased in a simple manner.

In order to further increase the reliability, additionally or alternatively, it can be provided that at least one actuator unit of the first actuator and at least one actuator unit of the second actuator act on the same component of the vehicle, in particular with adjusting movements in different frequency ranges, and a superordinate control is designed to control, in the event of failure of one of the actuator units, the remaining actuator unit so that it can take over the function of the failed actuator unit at least in part.

To this end additionally or alternatively it can also be provided that the first actuator unit and the second actuator unit of the first actuator act on the same component of the vehicle, in particular with adjusting movements in different frequency ranges, and a higher-order controller is designed, in the event of failure of one of the two actuator units to control the remaining actuator unit so that it can take over the function of the failed actuator unit at least in part.

Basically, it can be provided that the control of the other actuator takes place by a separate autonomous controller, which in each case receives corresponding orders from the superordinate controller of the vehicle and executes these autonomously. Preferably, however, it is provided that the control of the first actuator and of the second actuator takes place via a superordinate controller, which integrates parts of the control devices of the first and second actuator, and consequently performs their tasks.

In further preferred variants of the vehicle according to the invention at least one further actuator unit is provided, which, under the control of a control unit of the first actuator, can be supplied with working fluid from the power source of the first actuator. This further actuator does not necessarily have to be arranged in physical proximity to the first and second actuator unit. Rather, it can be a case here of a remotely arranged actuator unit. In this way it is possible in an advantageous fashion, to perform multiple adjustment tasks (of any kind) in the vehicle with just a single power source. Preferably, the further actuator unit is designed for the generation of adjusting movements for height levelling of the vehicle and/or for a brake of the vehicle and/or for an active damper of the vehicle.

Further preferred configurations of the invention result from the dependent claims or the following description of preferred exemplary embodiments, which refers to the attached drawings. It is shown in:

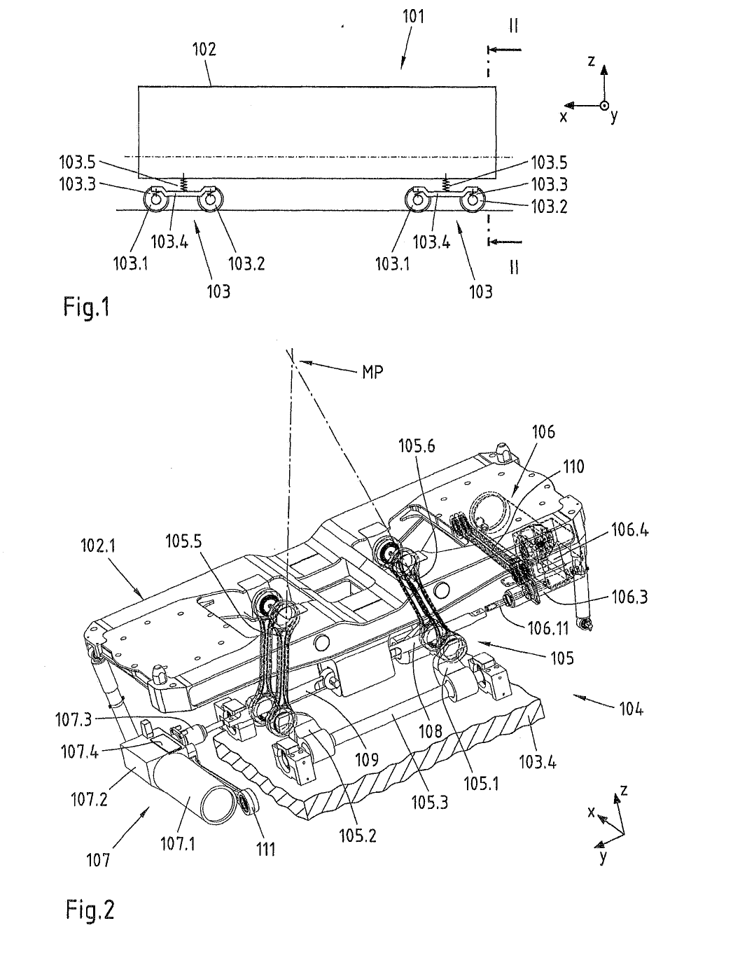

FIG. 1 a schematic side-view of a preferred embodiment of the vehicle according to the invention with a preferred embodiment of the actuator according to the invention;

FIG. 2 a schematic perspective view of part of the vehicle from FIG. 1 (in a cross-section along the line II-II from FIG. 1);

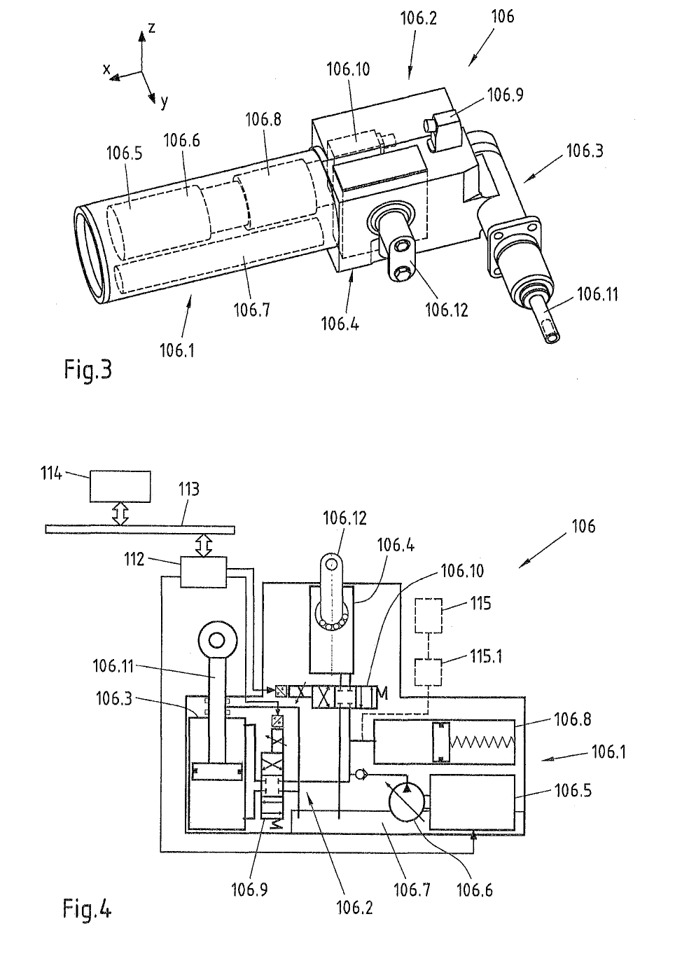

FIG. 3 a schematic perspective view of one of the actuators according to the invention from FIG. 2;

FIG. 4 a schematic block diagram of one of the actuators according to the invention from FIG. 2.

In the following, with reference to FIGS. 1 to 4, a preferred embodiment of the vehicle according to the invention in the form of a rail vehicle 101 is described.

For ease of understanding of the following explanations, in the figures a vehicle coordinate system x, y, z is indicated (set by the plane in which the wheels of the running gear 104 rest), in which the x coordinate designates the longitudinal direction of the rail vehicle 101, the y coordinate the transverse direction of the rail vehicle 101 and the z coordinate the vertical direction of the rail vehicle 101.

The vehicle 101 comprises a wagon body 102, which is supported in the area of its two ends in each case by a running gear in the form of a bogie 103. It is self-evident, however, that the present invention can also be used in connection with other configurations, in which the wagon body is merely supported by a single running gear.

The bogie 103, comprises two wheel units in the form of wheelsets 103.1 and 103.2, on which, in each case via a primary suspension 103.3, a bogie frame 103.4 is supported. The wagon body 102 is in turn supported by means of a secondary suspension 103.5 on the bogie frame 103.4. The primary suspension 103.3 and the secondary suspension 103.5 are shown in simplified form in FIG. 1 as helical springs. It is self-evident, however, that the primary suspension 103.3 or the secondary suspension 103.5 can involve any suitable suspension device. With the secondary suspension 103.2, in particular, it is preferably a case of a sufficiently known air suspension or similar.

FIG. 2 shows, in a perspective view as a detail of the vehicle 101, a roll compensation device 104, which in the area of each bogie 103 acts kinematically in parallel to the secondary suspension 103.5 between the bogie frame 103.4 and a wagon body traverse 102.1 connected to the wagon body 102 in the manner described in more detail in the following.

As can be seen, in particular, from FIG. 2, the roll compensation device 104 comprises an adequately known rolling support 105, which is connected at one end to the bogie frame 103.4 and at the other to the wagon body 102. FIG. 4 shows a perspective view of the rolling support 105. As can be seen from FIG. 2, the rolling support 105 comprises a torsion arm in the form of a first lever 105.1 and a second torsion arm in the form of a second lever 105.2. The two levers 105.1 and 105.2, on either side of the longitudinal plane (xz-plane) of the vehicle 101, sit in each case secured against rotation on the ends of a torsion shaft 105.3 of the rolling support 105. The torsion shaft 105.3 extends in the transverse direction (y-direction) of the vehicle 101 and is mounted rotatably in bearing blocks 105.4, which for their part are solidly connected to the bogie frame 103.2. At the free end of the first lever 105.1 a first connecting rod 105.5 is hinged, while at the free end of the second lever 105.2 a second connecting rod 105.6 is hinged. Via the two connecting rods 105.5, 105.6 the rolling support 105 has an articulated connection with the wagon body 102.

FIG. 2 shows the state in the neutral position of the vehicle 101, resulting from a journey on a straight track 106 without curves. In the present example, in this neutral position, the two connecting rods 105.5, 105.6 run in the sectional plane of FIG. 2 (yz-plane) at an inclination to the vertical axis (z-axis) of the vehicle 101, so that their upper ends (hinged with the wagon body 102) are displaced towards the centre of the vehicle and their longitudinal axes intersect at a point MP, which lies in the longitudinal plane (xz-plane) of the vehicle. By means of the connecting rods 105.5, 105.6, in a sufficiently known manner, (in the neutral position) a roll axis running parallel to the longitudinal vehicle axis 101.1 is defined, which passes through the point MP. The point of intersection MP of the longitudinal axes of the connecting rods 105.5, 105.6 in other words forms the instantaneous centre of rotation of a rolling motion of the wagon body 102 about this roll axis.

The rolling support 105 allows, in a sufficiently known manner, synchronous deflection on both sides of the vehicle of the secondary suspension 103.2, while preventing a pure rolling motion about the roll axis or the instantaneous centre of rotation MP. Furthermore, as can be seen in particular from FIG. 2, because of the inclined arrangement of the connecting rods 105.5, 105.6 through the rolling support 105 a kinematic configuration with a combined movement consisting of a roll motion about the roll axis or the instantaneous centre of rotation MP and a transverse motion in the direction of the transverse axis of the vehicle (y-axis) is specified. Here, it is self-evident that the point of intersection and thus the roll axis, because of the kinematic configuration specified by the connecting rods 105.5, 105.6, in the event of a deflection of the wagon body 102 from the neutral position as a rule similarly migrates sideways.

In order to be able to actively adjust the roll angle of the wagon body 102 about the roll axis or the instantaneous centre of rotation MP, in the present example, the vehicle 101 comprises a first actuator 106 providing multiple actuation and a second actuator 107 according to the invention providing multiple actuation, which provide the adjusting movements necessary for this. The two actuators 106 and 107 are for this purpose each secured on opposite sides of the bogie 103 to the bogie frame 103.4.

In order to set the roll angle of the wagon body 102 the first actuator 106 is connected via a first connecting rod 108 primarily running in the vehicle transverse direction (y-axis) with a projection from the wagon body traverse 102.1, while the second actuator 107 is connected via second connecting rod 109 likewise primarily running in the vehicle transverse direction (y-axis) with the projection from the wagon body traverse 102.1. Via the connecting rods 108 or 109 adjusting movements (primarily acting in the vehicle transverse direction) are transmitted from the actuators 106 or 107 to the wagon body traverse 102.1 and thus to the wagon body 102, in order in this way to achieve the desired roll motion on the wagon body 102.

The purpose of the first actuator 106 is to apply to the wagon body 102 via first adjusting movements a first roll angular deflection in a first frequency range of approximately 0.5 Hz to 1.0 Hz. It is thus a case here of a quasi-static roll angular deflection, which, for example, is matched to the curvature of a curve currently being travelled at a certain speed, in order to reduce, via a tilt control, the lateral acceleration acting on passengers (with this curved track and at this speed).

The purpose of the second actuator 107 is to apply to the wagon body 102, via second adjusting movements, a second roll angular deflection in a second frequency range (that is as far as possible above the first frequency range) of approximately 1.0 Hz to 6.0 Hz. In this way, therefore, it is a case here of a dynamic roll angular deflection, which for example is matched to the (mostly high-frequency) disturbances currently being introduced into the wagon body, in order to reduce, via a comfort control, the lateral acceleration on the passengers.

Basically, it can be provided that the active adjustment (taking place at least in the second frequency range) of the roll angle exclusively takes place when travelling a curve on a curved track, and so the two actuators 106 and 107 are only active in such a running condition. Preferably, however, it is provided that at least the second actuator 107 is also active when moving in a straight line, so that the vibration comfort in an advantageous manner is also guaranteed under such running conditions.

The two actuators 106 and 107 further serve to adjust the steering angle of wheelsets 103.1 and 103.2 about a rotary axis of the respective wheelset 103.1 or 103.2 running parallel to the vertical direction (z-axis). Such an active adjustment of the steering angle serves in a known fashion to avoid unstable running conditions and thus to increase the reliability, avoid annoying vibrations in the vehicle and so increase passenger comfort, and last but not least, to as far as possible optimise wear of the wheel and rail.

In order to adjust the steering angle of the wheelsets 103.1 and 103.2 the first actuator 106 is connected via a third connecting rod 110 (extending primarily in the longitudinal direction of the vehicle) with the wheel bearing housing of the first wheelset 103.1 located adjacent on this side of the running gear, while the second actuator 107 is connected via a fourth connecting rod 111 (extending primarily in the longitudinal direction of the vehicle) with the wheel bearing housing of the second wheelset 103.2 located adjacent on this side of the running gear. By means of the connecting rods 110 or 111 adjusting movements of the actuators 106 or 107 (acting primarily in the longitudinal direction of the vehicle 101) are transmitted to the wheelsets 103.1 or 103.2 in order in this way to achieve the desired turning movement on the respective wheelset 103.1 or 103.2.

Here it can be sufficient if, by means of the first actuator 106, only the first wheelset is adjusted, while by means of the second actuator 107 only the second wheelset 103.2 is operated, since, via the primary suspension 103.3 and the bogie frame 103.4, a sufficient mechanical coupling of the two wheelsets 103.1 and 103.2 is achieved. In advantageous variants of the present invention, however, a coupling (not shown in the figures) between the two wheelsets 103.1 and 103.2 is provided for, via which the adjusting movements on one wheelset are also introduced into the other wheelset.

The first actuator 106 serves to apply to the first wheelset 103.1, via third adjusting movements, a first steering angular deflection in a third frequency range of approximately 0.5 Hz to 1.0 Hz. It is thus a case here of a quasi-static steering angular deflection, which for example, is matched to the curvature of a curve currently being travelled, in order to achieve, in a wear control, a curve radial adjustment of the first wheelset 103.1.

The second actuator 107 serves to apply to the second wheelset 103.2, via fourth adjusting movements, a second steering angular deflection in a fourth frequency range (that is above the third frequency range) of approximately 4.0 Hz to 8.0 Hz. It is thus a case here of a dynamic steering angular deflection, which, for example, inter alia is matched to the disturbances (mostly high frequency, as a rule randomly distributed) currently being introduced into the bogie 103. In this way, in a comfort adjustment, the vibrations resulting from these disturbances can be reduced, as for example is known from WO 2007/137906 A1 quoted at the outset. The design and functioning of the actuators 106 and 107 is described in the following by way of example using the first actuator 106 depicted in FIGS. 3 and 4.

As can be seen from FIGS. 3 and 4, the actuator 106 is designed as a compact structural unit, which works according to a fluidic operating principle, namely hydraulically. To this end the actuator 106 comprises a fluidic power source 106.1, a control device 106.2, a first actuator unit 106.3 and a second actuator unit 106.4, which are assembled together to form a monolithic unit. So the two actuator units 106.3 and 106.4 are connected together to form a structural subunit, to which in turn the control device 106.2 and the power source 106.1 are flange-mounted.

The power source 106.1 comprises an electric motor 106.5, pump 106.6, reservoir 106.7 and buffer store 106.8. The pump 106.6 is flange-mounted to the motor 106.5 and together they form a compact immersion pump, which is arranged in the reservoir 106.7. The pump 106.6 delivers a working fluid in the form of hydraulic oil from the reservoir 106.7 to the buffer store 106.8, so that in the buffer store a predefined quantity of hydraulic oil is present, the pressure of which is at a predetermined pressure level.

The control device 106.2 is formed as a structural subunit in the form of a valve block, comprising a first valve unit 106.9 assigned to the first actuator unit 106.3 and a second valve unit 106.10 assigned to the second actuator unit 106.4.

The first actuator unit 106.3 is designed as a linear drive in the form of a dual-acting hydraulic cylinder, the working spaces of which can be connected alternately via a multi-port valve of the first valve unit 106.9 with the buffer store 106.8, in order to achieve the adjusting movements of the first actuator 106. The piston rod 106.11 of the first actuator unit 106.3 is connected with the first connecting rod 108, in order to introduce the first adjusting movements described above into the wagon body 102 and thus to generate the first roll angular deflection of the wagon body 102 in the first frequency range.

To this end a control module 112 controls the electromagnetically operated first valve unit 106.9 in the first frequency range of approximately 0.5 Hz to 1.0 Hz, in order to achieve the first adjusting movements of the first actuator unit 106.3 and thus of the first actuator 106 in this first frequency range.

In the present example the control module 112 for its part receives corresponding control commands via a data bus 113 (for example a CAN bus) from a superordinate vehicle controller 114. It is self-evident, however, that the chain of command, in other variants of the invention, can also be designed differently. In particular, purely analogue signalling paths can also be provided. Similarly, direct control of the control device 106.2 by the superordinate vehicle controller 114 can also be provided for.

In the present example only a first valve unit 106.9 is provided. It is self-evident, however, that in other variants of the invention a plurality of first valve units 106.9 (preferably two, integrated into the valve block 106.2) can be provided, in order to create in a simple manner redundancy and, thus, increase the reliability of the system. Here, it can be provided that in each case just one of the first valve units 106.9 is controlled by the control module 112. It is self-evident, however, that with other variants parallel operation of the first valve units 106.9 can be provided for.

The second actuator unit 106.4 is designed as a rotary drive in the form of a pivoting actuator, which can be connected to the buffer store 106.8 via a multi-port valve of the second valve unit 106.10 in order to achieve the third adjusting movements of the first actuator 106. The free end of the pivot lever 106.12 of the second actuator unit 106.4 is connected with the third connecting rod 110, in order to introduce the third adjusting movements described above into the first wheelset 103.1 and, thus, to generate the first steering angular deflection of the first wheelset 103.1 in the third frequency range.

To this end the control module 112 controls the electromagnetically operated second valve unit 106.10 in the third frequency range of approximately 0.5 Hz to 1.0 Hz, in order to achieve the adjusting movements of the second actuator unit 106.4 and thus of the first actuator 106 in this third frequency range.

In the present example, again, only one second valve unit 106.10 is provided. It is self-evident, however, that with other variants of the invention, again, a plurality of second valve units 106.10 (preferably two, preferably integrated into the valve block 106.2) can be provided, in order to create in a simple manner redundancy and, thus, to increase the reliability of the system. Here, it can be provided that in each case only one of the second valve units 106.10 is controlled by the control module 112. It is self-evident, however, that in other variants parallel operation of the second valve units 106.10 can also be provided for.

The fluidic connections within the first actuator 106 are exclusively created by channels in the respective components or housing parts of the first actuator 106. As a result the design of the first actuator 106 is thus (with the advantages already described above concerning the rigidity of the fluid system) substantially free from pipe and/or hose connections.

The design of the second actuator 107 (as already mentioned) is identical to that of the first actuator 106. It therefore comprises a power source 107.1, a control device 107.2, a third actuator unit 107.3 and a fourth actuator unit 107.4, which are assembled together to form a monolithic unit. The design of the third actuator unit 107.3 is identical to that of the first actuator unit 106.3, while the design of the fourth actuator unit 107.4 is identical to that of the second actuator unit 106.4.

The control device 107.2 (with a design identical to that of the control device 106.2) is controlled by the control module 112 in the second frequency range of approximately 1.0 Hz to 6.0 Hz so that the third actuator unit 107.3 performs the second adjusting movements described above of the second actuator 106 in this second frequency range.

Furthermore, the control device 107.2 is controlled by the control module 112 in the fourth frequency range of approximately 4.0 Hz to 8.0 Hz in such a way that the fourth actuator unit 107.4 performs the fourth adjusting movements described above of the second actuator 106 in this fourth frequency range.

In order to increase the reliability of the system as a whole, the control module 112 is designed so that, in the event of failure of one of the two actuator units 106.3 and 107.3, it controls the remaining actuator unit 106.3 or 107.3 in such a way that it takes over the function of the failed actuator unit 106.3 or 107.3 at least in part.

In the present example the first actuator 106 and the second actuator 107 are connected together by means of a hydraulic line (not shown in more detail) in a fluidic manner so that, in the event of failure of the power source 106.1 or 107.1 of one of the actuators 106.1 or 107.1, via a corresponding valve located in this hydraulic line and controlled by the control module 112, the power source of the other actuator 107.1 or 106.1 can take over the power supply to both actuators 106 and 107. In this way the reliability of the system as a whole is increased in a simple manner.

The actuators 106, 107 have a modular design, so that different performance and functional requirements can be met with little effort. Additionally, extensive diagnostic functions are provided, which can detect in due time all essential failure modes of the actuators 106, 107 allowing repair or exchange of the components concerned without adversely affecting operation.

In further variants of the vehicle according to the invention 101 at least one further actuator unit is provided, as shown in FIG. 4 by the dashed outline 115. This further actuator unit 115 is supplied with the hydraulic fluid, via a control unit 115.1 of the first actuator 106, from the power source 106.1. This further actuator does not necessarily have to be arranged in physical proximity to the first and second actuator units 106.3, 106.4. Rather it can be a case here of a remotely arranged actuator unit. In this way it is possible in an advantageous fashion, to perform with just a single power source 106.1 a plurality of adjustment tasks (of arbitrary kind) in the vehicle.

The further actuator unit 115 is preferably designed for generating adjusting movements for height levelling of the vehicle 101 and/or for a brake of the vehicle 101 and/or for an active damper of the vehicle 101 and/or for an additional device for (quasi-static and/or dynamic) influencing of the deflection of the wagon body 102 in the transverse direction of the vehicle.

It is self-evident here, that all the abovementioned functions can also be performed in the area of the vehicle 101 on their own or, of course, in arbitrary combination by the first and/or second actuator unit of the first actuator.

In the present example, the actuator units 106.3, 106.4 of the first actuator 106 both operate in the lower first and third frequency range, while the actuator units 107.3, 107.4 of the second actuator 107 both operate in the higher second and fourth frequency range. It is self-evident, however, that with other variants of the invention it can also be provided that the actuator units 106.3, 106.4 of the first actuator 106 work in differing frequency ranges. Thus, for example, it can be provided that the second actuator unit 106.4 works in the higher fourth frequency range. In this case the fourth actuator unit 107.4 then operates in the lower, second frequency range.

In further variants of the vehicle according to the invention it can be provided that the actuator units 106.3, 106.4 of the first actuator 106 operate in the first or second frequency range on the wagon body 102, wherein they can then for example both be designed as linear actuators (or also both as a pivoting actuator). In order to increase the reliability of the system as a whole, the control module 112 is then preferably designed in such a way that, in the event of failure of one or both actuator units 106.3, 106.4, it controls the remaining actuator unit 106.3 or 106.4 so that it takes over the function of the failed actuator unit 106.3 or 106.4 at least in part.

The same can apply, with this variant, for the second actuator 107, the actuator units 107.3, 107.4 of which (then for example both designed as pivoting drives or linear actuators) act on the wheelsets 103.1 and 103.2 in the third or fourth frequency range.

It is to be stated at this point that, with further variants of the actuator according to the invention, two or a plurality of individual actuator units of any kind (linear, rotary, etc.) and direction of action can be used. Similarly all mounted actuator units can be controlled independently of one another via their own valve units, wherein the frequencies, amplitudes and force levels of the adjusting movements can be selected and combined with one another as desired.

It is self-evident that the arrangement of the actuators 106, 107 according to the invention, in particular their respective direction of action, can be selected according to the running gear type, application and functional requirements. Thus, for example, it can be provided that the motor/pump unit is integrated in the vehicle transverse direction or in the vehicle longitudinal direction within the bogie frame 103.4.

The present invention has been described above exclusively using examples of rail vehicles. It is self-evident, however, that the invention can also be used in connection with any other vehicles.

Finally, it is self-evident that the actuator according to the invention can of course also be used in connection with any other applications outside of vehicle construction.

1. An actuator, in particular for a rail vehicle, comprising:
a fluidic first actuator unit and
a control device having a first control unit, wherein
first actuator unit is connected to the first control unit and can be supplied with power from a fluidic power source under the control of the first control unit,
wherein
a fluidic second actuator unit is provided and
the control device comprises a second control unit, wherein
the second actuator unit is connected to the second control unit and can be supplied with power from the fluidic power source under the control of the second control unit.

2. The actuator according to claim 1, wherein
it is designed as a structural unit, in particular with a shared housing, wherein, in particular,
the first control unit and the second control unit take the form of a structural subunit, in particular with a shared housing,
and/or
the first actuator unit and the second actuator unit take the form of a structural subunit, in particular with a shared housing, wherein the first actuator unit and the second actuator unit are arranged directly adjacent to one another,
and/or
the power source takes the form of a structural subunit, in particular with a motor, a pump driven by the motor for a working fluid, and a buffer store supplied by the pump with the working fluid in a shared housing.

3. The actuator according to claim 1, wherein
the first control unit comprises at least one first valve unit, which controlled by a control module of the control device connects the power source in a fluidic manner with the first actuator unit, wherein
the first control unit comprises, in particular, two first valve units, which can be controlled separately, in particular by the control module, and/or operated in parallel, and/or
the second control unit comprises at least one second valve unit, which controlled by a control module of the control device connects the power source in a fluidic manner with the second actuator unit, wherein
the second control unit comprises, in particular, two second valve units, which can be controlled separately, in particular by the control module, and/or operated in parallel.

4. The actuator according to claim 3, wherein
the control device is designed to control the first control unit for operation of the first actuator unit in a first frequency range, and
the control device is designed to control the second control unit for operation of the second actuator unit in a second frequency range, wherein
the second frequency range, in particular, is at least partially, in particular completely, above the first frequency range and/or
the first frequency range extends, in particular, from 0 Hz to 2 Hz, preferably from 0.5 Hz to 1.0 Hz, and/or
the second frequency range extends, in particular, from 0.5 Hz to 15 Hz, preferably from 1.0 Hz to 6.0 Hz.

5. The actuator according to claim 4, wherein
the first control unit comprises two first valve units, wherein at least one of the first valve units is designed for control in the second frequency range, and/or
at least one of the first valve units is designed for control in the second frequency range, and/or
the second control unit comprises two second valve units, wherein at least one of the second valve units is designed for control in the first frequency range.

6. The actuator according to claim 1, wherein
at least one of the actuator units is an actuator unit with a rotary operation and/or at least one of the actuator units is an actuator unit with translational movement, wherein
the first actuator unit and the second actuator unit, in particular, have a different direction of action.

7. The actuator according to claim 1, wherein
at least a further, third actuator unit is provided, wherein
the third actuator unit is connected with a third control unit of the control device and can be supplied, under the control of the third control unit, with power from the power source,
in particular, at least two third actuator units are provided.

8. The actuator according to claim 1, wherein
it is substantially free from internal fluidic pipe and/or hose connections, wherein, in particular,
the first control unit is designed as a valve block, which, in order to create the fluidic connection, is flange-mounted to the first actuator unit and/or the power source, and/or
the second control unit is designed as a valve block, which, in order to create the fluidic connection, is flange-mounted to the second actuator unit and/or the power source.

9. The actuator according to claim 1, wherein, as the working fluid, a liquid medium, in particular hydraulic oil, is used.

10. A vehicle, in particular a rail vehicle, comprising:
a running gear,
a wagon body supported by the running gear,
a first actuator, which is designed as an actuator according to claim 1, and,
in particular, a second actuator, which is designed as an actuator according to claim 1, wherein
the first actuator and/or the second actuator, in particular, acts in the area of the running gear and/or between the running gear and the wagon body.

11. The vehicle according to claim 10, wherein
the wagon body can be tilted about a longitudinal axis of the vehicle and
at least one actuator unit of the first actuator is designed to adjust a tilting angle of the wagon body about the longitudinal axis, in particular, in a first frequency range, wherein,
in particular, at least one further actuator unit of the first actuator and/or of the second actuator is designed to set the tilting angle of the wagon body in a second frequency range,
wherein the second frequency range, in particular, lies at least partially, in particular completely, above the first frequency range.

12. The vehicle according to claim 10, wherein
the running gear has at least one wheel unit designed to be steerable about a vertical axis of the vehicle and
at least one actuator unit of the first actuator is designed to set a steering angle of the wheel unit, in particular in a third frequency range, about the vertical axis, wherein,
in particular, at least one further actuator unit of the first actuator and/or of the second actuator is designed to set the steering angle of the wheel unit in a fourth frequency range,
wherein the fourth frequency range lies, in particular, at least partially, in particular completely, above the third frequency range.

13. The vehicle according to claim 10, wherein
the first actuator and the second actuator are connected with one another in a fluidic manner, so that, in the event of failure of the power source of one actuator, the power source of the other actuator can take over the power supply to both actuators,
and/or
at least one actuator unit of the first actuator and at least one actuator unit of the second actuator act on the same component of the vehicle, in particular, with adjusting movements in different frequency ranges, and a superordinate controller is designed to control, in the event of failure of one of the two actuator units, the remaining actuator unit so that it at least partially takes over the function of the failed actuator unit,
the first actuator unit and the second actuator unit of the first actuator act on the same component of the vehicle, in particular with adjusting movements in differing frequency ranges, and a superordinate controller is designed to control, in the event of failure of one of the two actuator units (106.3, 106.4), the remaining actuator unit so that it at least in part takes over the function of the failed actuator unit.

14. The vehicle according to claim 10, wherein control of the first actuator and of the second actuator takes place via a superordinate controller, which integrates parts of the control devices of the first and second actuator.

15. The vehicle according to claim 10, wherein
at least one further actuator unit is provided, which via a control unit of the first actuator can be supplied with working fluid from the power source of the first actuator, wherein
the further actuator unit, in particular, is designed for generating adjusting movements for height levelling of the vehicle and/or for a brake of the vehicle and/or for an active damper of the vehicle and/or for an additional device for influencing the deflection of the wagon body in the transverse direction of the vehicle.
